(19) United States
(12) Patent Application Publication
(10) Pub. No.: US 2026/0174012 A1
(43) Pub. Date: Jun. 25, 2026

(54) AGRICULTURAL SYSTEM AND METHOD FOR REMOVING TRASH FROM A FLOW OF HARVESTED CROP WITHIN AN AGRICULTURAL HARVESTER

(71) Applicant: CNH Industrial America LLC, New Holland, PA (US)

(72) Inventors: Carlos Eduardo de Carvalho Visconti, São Paulo (BR); André Satoshi Seki, Sorocaba (BR); Bart M.A. Missotten, Herent (BE); Dré W.J. Jongmans, Klundert (BE); Thomas Mahieu, Leper (BE); Lawrence Anthony Polga, Queensland (AU)

(21) Appl. No.: 18/713,410

(22) PCT Filed: Nov. 17, 2022
(86) PCT No.: PCT/BR2022/050445

§ 371 Date: May 24, 2024

(30) Foreign Application Priority Data
Nov. 25, 2021 (BR) 1020210237040

(51) Int. Cl. A01D 43/08; A01D 41/12

(52) U.S. Cl. CPC A01D 43/086; A01D 41/1217; A01D 43/087

(57) ABSTRACT

An agricultural system for removing trash from a flow of harvested crop within an agricultural harvester may include an extractor assembly comprising a shroud and an actuator configured to adjust a position of the shroud. The shroud has an inlet through which trash enters the shroud and an outlet through which the trash exits the shroud. The agricultural system may further include a flow direction sensor having a field of view directed toward the trash exiting the shroud, the flow direction sensor configured to generate data indicative of at least a flow direction of the trash. Additionally, the agricultural system may include a computing system. The computing system may determine the flow direction of the trash exiting the shroud based on data received from the flow direction sensor and control an operation of the actuator to adjust the position of the shroud based on the flow direction of the trash.

### FIELD OF THE INVENTION

The present disclosure relates generally to agricultural harvesters, such as sugarcane harvesters, and, more particularly, to agricultural systems and methods for removing trash from a flow of harvested crop within an agricultural harvester.

### BACKGROUND OF THE INVENTION

Typically, agricultural harvesters include an assembly of processing equipment for processing harvested crop materials. For instance, within a sugarcane harvester, severed sugarcane stalks are conveyed via a feed roller assembly to a chopper assembly that cuts or chops the sugarcane stalks into pieces or billets (e.g., 6 inch cane sections). The processed crop material discharged from the chopper assembly is then directed as a stream of billets and debris into a primary extractor assembly, within which the airborne debris (e.g., dust, dirt, leaves, etc.) is separated from the sugarcane billets. The separated/cleaned billets then fall into an elevator assembly for delivery to an external storage device. A secondary extractor assembly may remove further debris (e.g., dust, dirt, leaves, etc.) from the sugarcane billets moving through the elevator assembly before the sugarcane billets exit the elevator assembly.

The primary extractor assembly typically extends vertically above the chopper assembly, proximate an inlet end of the elevator assembly relative to the flow of harvested crop materials moving through the agricultural harvester and exhausts the separated debris rearward of the agricultural harvester. The secondary extractor assembly typically extends from an upper side of the elevator assembly housing, proximate an outlet end of the elevator housing, and exhausts separated debris above the outlet end of the elevator housing. However, the direction of wind flowing past the harvester may undesirably cause debris separated by the primary extractor assembly from spreading evenly across the field and/or cause debris separated by the secondary extractor assembly to be directed into the external storage device and recombined with cleaned billets.

Accordingly, an improved agricultural system and method for removing trash from a flow of harvested crop within an agricultural harvester would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an agricultural system for removing trash from a flow of harvested crop within an agricultural harvester. The agricultural system includes an extractor assembly having a shroud and an actuator. The shroud has an inlet through which trash from the flow of harvested crop enters the shroud and an outlet through which the trash exits the shroud. The actuator is configured to adjust a position of the shroud. The agricultural system further includes a flow direction sensor having a field of view directed toward the trash exiting the shroud, the flow direction sensor being configured to generate data indicative of at least a flow direction of the trash exiting the shroud. Additionally, the agricultural system includes a computing system communicatively coupled to the actuator and the flow direction sensor. The computing system is configured to determine the flow direction of the trash exiting the shroud based at least in part on data received from the flow direction sensor, and to control an operation of the actuator to adjust the position of the shroud based at least in part on the flow direction of the trash.

In another aspect, the present subject matter is directed to a method for removing trash from a flow of harvested crop within an agricultural harvester, the agricultural harvester including an extractor assembly with a shroud having an inlet through which trash from the flow of harvested crop enters the shroud and an outlet through which the trash exits the shroud. The method includes receiving, with a computing system, data from a flow direction sensor having a field of view directed toward the trash exiting the shroud, the data being indicative of at least a flow direction of the trash exiting the shroud. Further, the method includes determining, with the computing system, the flow direction of the trash based at least in part on the data from the flow direction sensor. Additionally, the method includes controlling, with the computing system, an operation of an actuator to adjust a position of the shroud based at least in part on the flow direction of the trash.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, side view of one embodiment of an agricultural harvester in accordance with aspects of the present subject matter;

FIG. 2 illustrates a schematic view of an agricultural system for removing trash from a flow of harvested crop within an agricultural harvester in accordance with aspects of the present subject matter;

FIGS. 3A and 3B illustrate top-down views of one embodiment of an agricultural system in accordance with aspects of the present subject matter, particularly illustrating an adjustment of an extractor shroud(s) of an agricultural harvester; and

FIG. 4 illustrates a flow diagram of one embodiment of an agricultural method for removing trash from a flow of harvested crop within an agricultural harvester in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to agricultural systems and methods for removing trash from a flow of harvested crop within an agricultural harvester, such as a sugarcane harvester. Particularly, in several embodiments, the disclosed agricultural systems and methods may be used to direct trash exhausted from an extractor assembly of an agricultural harvester in response to the flow direction of the trash leaving the extractor assembly. For instance, an agricultural harvester may include a primary extractor assembly and/or a secondary extractor assembly. The primary extractor assembly may be configured to remove trash from the flow of harvested crop before the flow of harvested crop reaches the elevator assembly, and to exhaust the separated trash at a location at an aft end of the harvester. The secondary extractor assembly may be configured to remove trash from the flow of harvested crop as it moves through the elevator assembly, and to exhaust the separated trash at a location proximate the exit of the elevator assembly. Depending on the wind flowing past the agricultural harvester, the separated trash may not be exhausted in an ideal way. For instance, the trash exhausted by the primary extractor assembly may be blown to create an uneven residue layer on the field aft of the harvester, and/or the trash exhausted by the secondary extractor assembly may be blown into a trailer meant only to hold crop discharged from the elevator assembly. The primary and/or secondary extractor assembly may be configured to slew about a respective axis to direct the exhausted trash as it exits the extractor. However, the slewing of the extractor shroud(s) is usually manually controlled, which means that the slew angle is not adjusted as frequently or quickly as necessary to prevent such unideal exhausting of the trash. As such, in accordance with aspects of the present subject matter, an automatic agricultural system and method are provided, where the slewing of the extractor shroud(s) is automatically controlled based on a direction and/or speed of the trash as it exits the extractor shroud(s).

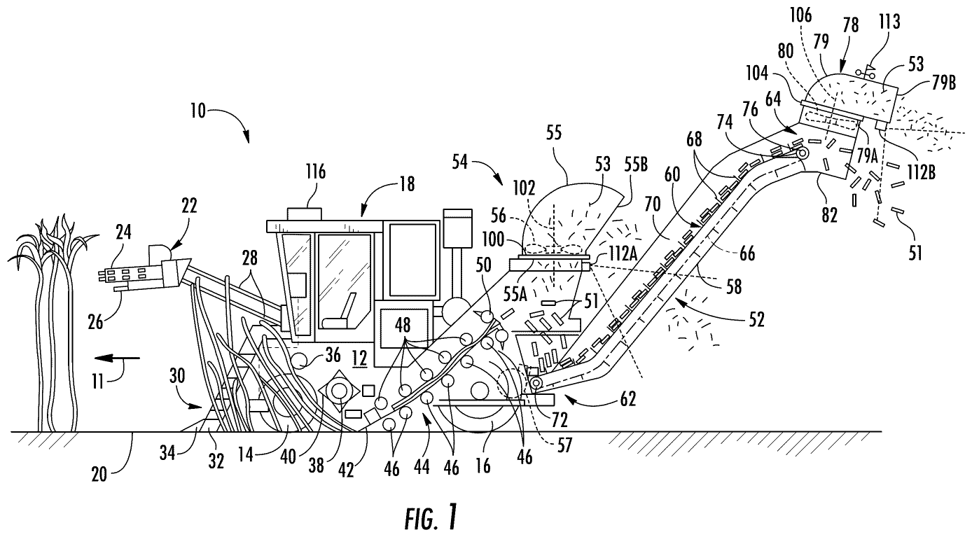

Referring now to the drawings, FIG. 1 illustrates a side view of one embodiment of an agricultural harvester 10 in accordance with aspects of the present subject matter. As shown, the harvester 10 is configured as a sugarcane harvester. However, in other embodiments, the harvester 10 may correspond to any other suitable agricultural harvester known in the art.

As shown in FIG. 1, the harvester 10 includes a frame 12, a pair of front wheels 14, a pair of rear wheels 16, and an operator's cab 18. The harvester 10 may also include a primary source of power (e.g., an engine mounted on the frame 12) which powers one or both pairs of the wheels 14, 16 via a transmission (not shown). Alternatively, the harvester 10 may be a track-driven harvester and, thus, may include tracks driven by the engine as opposed to the illustrated wheels 14, 16. The engine may also drive a hydraulic fluid pump (not shown) configured to generate pressurized hydraulic fluid for powering various hydraulic components of the harvester 10.

The harvester 10 may include various components for cutting, processing, cleaning, and discharging sugarcane as the cane is harvested from an agricultural field 20. For instance, during operation, the harvester 10 is traversed in a travel direction 11 across an agricultural field 20 for harvesting crop, such as sugarcane. The harvester 10 may include a topper assembly 22 positioned at its front end to intercept sugarcane as the harvester 10 is moved in the forward direction. As shown, the topper assembly 22 may include both a gathering disk 24 and a cutting disk 26. The gathering disk 24 may be configured to gather the sugarcane stalks so that the cutting disk 26 may be used to cut off the top of each stalk. As is generally understood, the height of the topper assembly 22 may be adjustable via a pair of arms 28 hydraulically raised and lowered, as desired, by the operator. After the height of the topper assembly 22 is adjusted via the arms 28, the gathering disk 24 on the topper assembly 22 may function to gather the sugarcane stalks as the harvester 10 proceeds across the field 20, while the cutter disk 26 severs the leafy tops of the sugarcane stalks for disposal along either side of harvester 10.

The harvester 10 may further include a crop divider 30 that extends upwardly and rearwardly from the field 20. In general, the crop divider 30 may include two spiral feed rollers 32. Each feed roller 32 may include a ground shoe 34 at its lower end to assist the crop divider 30 in gathering the sugarcane stalks for harvesting. As the stalks enter the crop divider 30, the ground shoes 34 may set the operating width to determine the quantity of sugarcane entering the throat of the harvester 10. The spiral feed rollers 32 then gather the stalks into the throat to allow a knock-down roller 36 to bend the stalks downwardly in conjunction with the action of a fin roller 38. The knock-down roller 36 is positioned near the front wheels 14 and the fin roller 38 positioned behind or downstream of the knock-down roller 36. As the knock-down roller 36 is rotated, the sugarcane stalks being harvested are knocked down. The fin roller 38 may include a plurality of intermittently mounted fins 40 that assist in forcing the sugarcane stalks downwardly. For instance, as the fin roller 38 is rotated, the sugarcane stalks that have been knocked down by the knock-down roller 36 are separated and further knocked down by the fin roller 38 as the harvester 10 continues to be moved in the forward direction relative to the field 20.

Once the stalks are angled downwardly as shown in FIG. 1, a base cutter assembly 42 may then sever the base of the stalks from field 20. The base cutter assembly 42 is positioned behind or downstream of the fin roller 38. As is generally understood, the base cutter assembly 42 may include blades (not shown) for severing the sugarcane stalks as the cane is being harvested. The blades, located on the periphery of the assembly 42, may be rotated by a hydraulic motor (not shown) powered by the vehicle's hydraulic system. Additionally, in several embodiments, the blades may be angled downwardly to sever the base of the sugarcane as the cane is knocked down by the fin roller 38.

The severed stalks are then, by movement of the harvester 10, directed to a feed roller assembly 44 located downstream of the base cutter assembly 42 for moving the severed stalks of sugarcane from base cutter assembly 42 along the processing path. As shown in FIG. 1, the feed roller assembly 44 may include a plurality of bottom rollers 46 and a plurality of opposed, top pinch rollers 48. The harvested sugarcane may be pinched between various bottom and top rollers 46, 48 to make the sugarcane stalks more uniform and to convey the harvested sugarcane rearwardly (downstream) during transport. As the sugarcane is transported through the feed roller assembly 44, debris (e.g., rocks, dirt, and/or the like) may be allowed to fall through bottom rollers 46 onto the field 20.

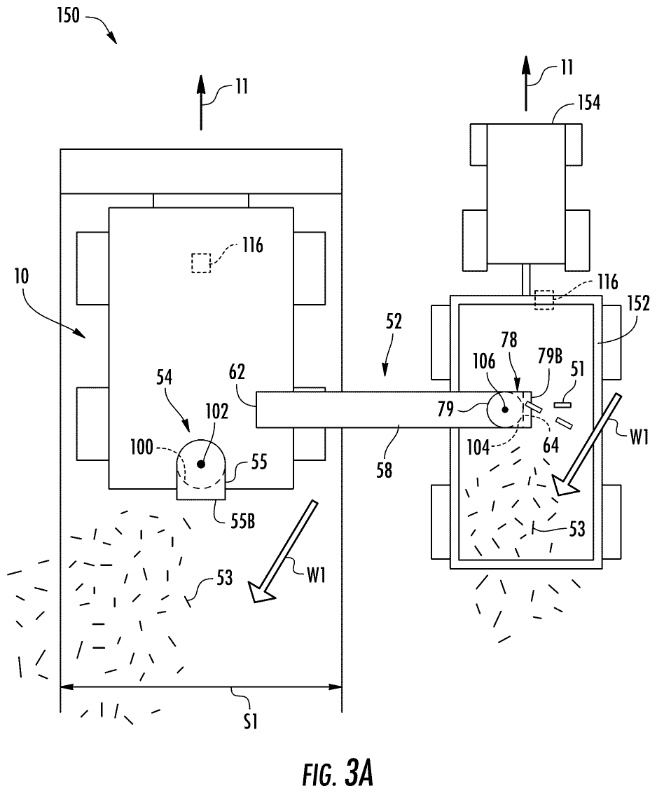

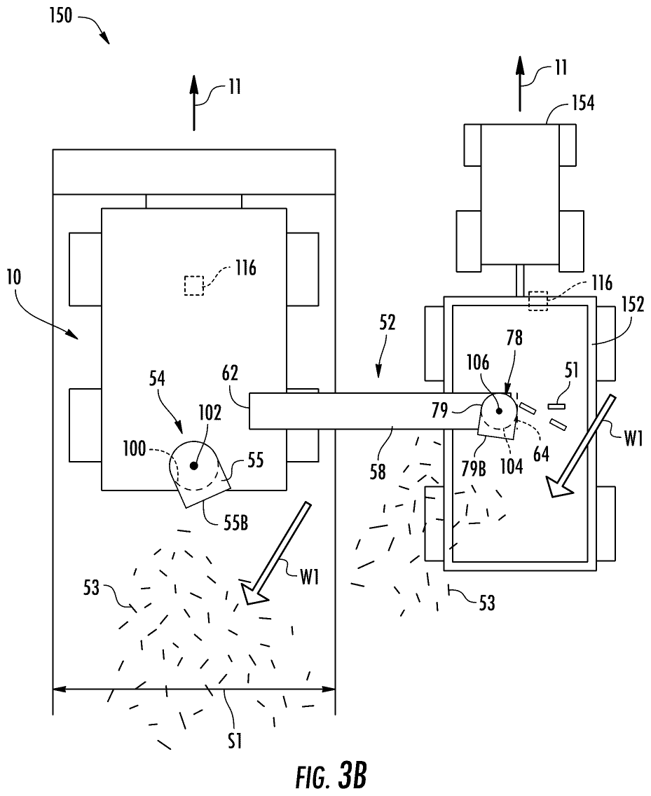

At the downstream end of the feed roller assembly 44 (e.g., adjacent to the rearward-most bottom and top rollers 46, 48), a chopper assembly 50 may cut or chop the compressed sugarcane stalks. In general, the chopper assembly 50 may be used to cut the sugarcane stalks into pieces or “billets” 51, which may be, for example, six (6) inches long. The billets 51 may then be propelled towards an elevator assembly 52 of the harvester 10 for delivery to an external receiver or storage device (FIGS. 3A and 3B).

As is generally understood, a primary extractor assembly 54 may be provided to help separate pieces of debris 53 (e.g., dust, dirt, leaves, etc.) from the sugarcane billets 51 before the billets 51 are received by the elevator assembly 52. The primary extractor assembly 54 is located immediately behind or downstream of the chopper assembly 50 relative to the flow of harvested crop and is oriented to direct the debris 53 outwardly from the harvester 10. The primary extractor assembly 54 may include an extractor fan 56 mounted within a hood or shroud 55 for generating a suction force or vacuum sufficient to separate and force the debris 53 through an inlet 55A of the shroud 55 into the primary extractor assembly 54 and out of the harvester 10 via an outlet 55B of the shroud 55. The shroud 55 of the primary extractor assembly 54 may be rotatably coupled to the housing of the agricultural harvester 10 by a slewing ring bearing 100 such that the shroud 55 may slew or rotate about an axis 102 to adjust a flow direction of trash 53 exiting the shroud 55. The separated or cleaned billets 51 are heavier than the debris 53 being expelled through the extractor 54, so the billets 51 may fall downward to the elevator assembly 52 instead of being pulled through the primary extractor assembly 54.

In some embodiments, an agitator fan 57 may be provided to disperse and direct the flow of crop materials exiting the chopper assembly 50. For instance, the agitator fan 57 may be positioned below the chopper assembly 50 and configured to generate a flow of air upwards towards the primary extractor assembly 54. By dispersing the flow of crop materials directed toward the primary extractor assembly 54, the primary extractor assembly 54 may better separate the trash from the billets. In one embodiment, the agitator fan 57 may be configured as a centrifugal fan, however, the agitator fan 57 may otherwise be configured as any other suitable type of fan.

As further shown in FIG. 1, the elevator assembly 52 may include an elevator housing 58 and an elevator 60 disposed and extending within the elevator housing 58 between a lower, inlet end 62 and an upper, outlet end 64. In general, the elevator 60 may include a looped chain 66 and a plurality of flights or paddles 68 attached to and evenly spaced on the chain 66. The paddles 68 may be configured to hold the sugarcane billets 51 on the elevator 60 as the billets are elevated along a top span of the elevator 70 defined between its inlet and outlet ends 62, 64. Additionally, the elevator 60 may include lower and upper sprockets 72, 74 positioned at its inlet and outlet ends 62, 64, respectively. As shown in FIG. 1, an elevator motor 76 may be coupled to one of the sprockets (e.g., the upper sprocket 74) for driving the chain 66, thereby allowing the chain 66 and the paddles 68 to travel in an endless loop between the inlet and outlet ends 62, 64 of the elevator 60. However, it should be appreciated that the elevator 60 may be configured in any other suitable way.

Moreover, in some embodiments, pieces of debris or trash 53 (e.g., dust, dirt, leaves, etc.) separated from the elevated sugarcane billets 51 may be expelled from the harvester 10 through a secondary extractor assembly 78 coupled to the rear end of the elevator housing 58. For example, the debris 53 expelled by the secondary extractor assembly 78 may be debris remaining after cleaning by the primary extractor assembly 54. As shown in FIG. 1, the secondary extractor assembly 78 may be located adjacent to the outlet end 64 of the elevator 60 and may be oriented to direct the debris 53 outwardly from the harvester 10. The secondary extractor assembly 78 may include an extractor fan 80 mounted within a hood or shroud 79 for generating a suction force or vacuum sufficient to separate and force the debris 53 through an inlet 79A of the shroud 79 into the secondary extractor assembly 78 and out of the harvester 10 via an outlet 79B of the shroud 79. The shroud 79 of the secondary extractor assembly 78 may be rotatably movable relative to the elevator housing 58, preferably closer to the upper, outlet end 64 of the elevator housing 58, by a slewing ring bearing 104 such that the shroud 79 may slew or rotate about an axis 106 to adjust a flow direction of trash 53 exiting the shroud 79. The separated, cleaned billets 51, heavier than the debris 53 expelled through the secondary extractor assembly 78, may then fall from the outlet end 64 of the elevator 60. Typically, the billets 51 may fall downwardly through an elevator discharge opening 82 of the elevator assembly 52 into an external storage device (FIGS. 3A and 3B), such as a sugarcane billet cart.

As will be described in greater detail below, the shrouds 55, 79 of the primary and secondary extractor assemblies 54, 78 may be automatically slewed to adjust a flow direction of trash exiting the shroud 55, 79. For instance, shrouds 55, 79 of the primary and secondary extractor assemblies 54, 78 may be automatically slewed based at least in part on data from one or more sensors that is indicative of at least a flow direction of the trash exiting the extractor assemblies 54, 78. For instance, in one embodiment, a first sensor 112A may be positioned proximate the primary extractor assembly 54 such that it has a field of view directed toward the trash exiting the shroud. The first sensor 112A is configured to generate data indicative of the flow direction of the trash 53 exiting the shroud 55 of the primary extractor assembly 54. Similarly, in one embodiment, a second sensor 112B may be positioned proximate the secondary extractor assembly 78 such that it has a field of view directed toward the trash exiting the shroud. The second sensor 112B is similarly configured to generated data indicative of the flow direction of the trash 53 exiting the shroud 79 of the secondary extractor assembly 78. Additionally, in some embodiments, the field of view of at least the second sensor 112B may include a portion of a trailing storage vehicle 152 (FIGS. 3A and 3B) such that the data from the second sensor 112B may be configured to indicate a flow direction of the trash 53 relative to the trailing storage vehicle 152. The sensor(s) 112A, 112B may generally be non-mechanical sensors configured to monitor the actual behavior of the trash 53 exiting the shroud 79. For instance, each sensor(s) 112A, 112B may include one or a combination of optical sensors (e.g., camera(s), LIDAR device(s), etc.), radar device(s), and/or the like configured to generate data (e.g., image data, point-cloud data, etc.), radar data, and/or the like indicative of the flow direction of the trash 53 and, in some instances, the speed of the flow of trash 53.

Alternatively, or additionally, one or more wind sensors 113 may be provided on the agricultural harvester 10 and/or within the field being harvested that generate data indicative of wind direction, and optionally speed, which may, in turn, be indirectly indicative of the flow direction of the trash 53. For instance, the wind sensors 113 may include a wind vane for generating data indicative of the wind direction, and optionally an anemometer for generating data indicative of the wind speed.

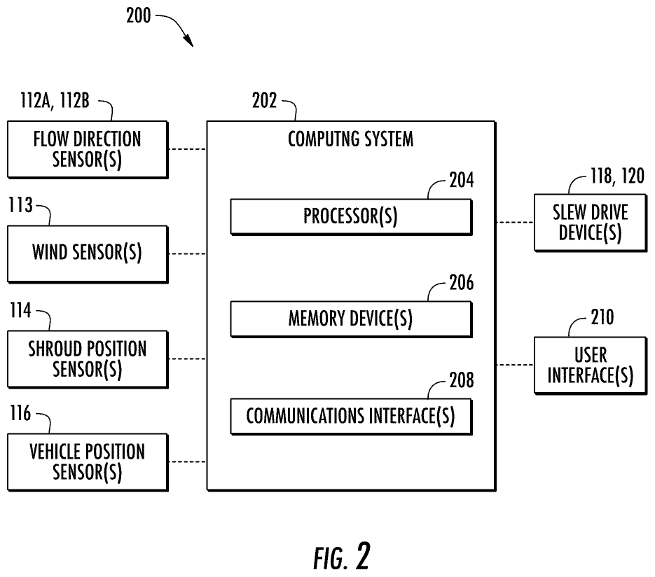

Referring now to FIG. 2, a schematic view of one embodiment of a system 200 for removing trash from a flow of harvested crop within an agricultural harvester is illustrated in accordance with aspects of the present subject matter. In general, the system 200 will be described with reference to the agricultural harvester 10 described with reference to FIG. 1. However, it should be appreciated that the disclosed system 200 may be implemented with harvesters having any other suitable configurations.

In several embodiments, the system 200 may include a computing system 202 and various other components, features, systems and/or sub-systems configured to be communicatively coupled to the computing system 202. In general, the computing system 202 may be configured to perform various computer-related functions or tasks, including, for example, receiving data from one or more components, features, systems and/or sub-systems of the harvester 10, storing and/or processing data received or generated by the computing system 202, and/or controlling the operation of one or more components, features, systems and/or sub-systems of the agricultural harvester 10.

In general, the computing system 202 may comprise any suitable processor-based device known in the art, such as a computing device or any suitable combination of computing devices. Thus, as shown in FIG. 3, the computing system 202 may include one or more processor(s) 204, and associated memory device(s) 206 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 206 of the computing system 202 may generally comprise memory element(s) including, but not limited to, a computer readable medium (e.g., random access memory RAM)), a computer readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 206 may generally be configured to store suitable computer-readable instructions that, when implemented by the processor(s) 204, configure the computing system 202 to perform various computer-implemented functions, such as one or more aspects of the methods and algorithms that will be described herein. In addition, the computing system 202 may also include various other suitable components, such as a communications circuit or module, one or more input/output channels, a data/control bus and/or the like.

It should be appreciated that, in several embodiments, the computing system 202 may correspond to an existing computing system of the agricultural harvester 10. However, it should be appreciated that, in other embodiments, the computing system 202 may instead correspond to a separate processing device. For instance, in one embodiment, the computing system 202 may form all or part of a separate plug-in module that may be installed within the agricultural harvester 10 to allow for the disclosed system and method to be implemented without requiring additional software to be uploaded onto existing control devices of the agricultural harvester 10.

As further shown in FIG. 3, the system 200 may include a computing system 202 and various other components configured to be communicatively coupled to and/or controlled by the computing system 202. For instance, the computing system 202 may be communicatively coupled to: the sensor(s) configured to generate data indicative of the actual flow direction of the trash exiting the extractor assembly(ies) 54, 78 (e.g., first sensor(s) 112A, and/or second sensor(s) 112B); the wind sensor(s) 113 configured to generate data indicative of wind direction and/or wind speed; one or more shroud position sensors 114 configured to generate data indicative of a position (e.g., slew angle) of the shroud(s) 55, 79; one or more vehicle position sensors 116 configured to generate data indicative of a position of the harvester 10 and a position of a trailer (e.g., trailer 152 in FIGS. 3A and 3B); one or more slew drive devices 118, 120 for slewing the shroud(s) 55, 79; and/or to one or more user interfaces 210. As such, the computing system 202 may be configured to receive inputs from the sensor(s) 112, 113, 114, 116 and to control the operation of the slew drive device(s) 118, 120 and/or the user interface 210 based at least in part on the input(s) from one or more of the sensors 112, 113, 114, 116. The user interface 210 described herein may include, without limitation, any combination of input and/or output devices that allow an operator to provide operator inputs to the computing system 202 and/or that allow the computing system 202 to provide feedback to the operator, such as a keyboard, keypad, pointing device, buttons, knobs, touch sensitive screen, mobile device, audio input device, audio output device, and/or the like.

Additionally, in some embodiments, the computing system 202 may be configured to include one or more communications modules or interfaces 208 for the computing system 202 to communicate with any of the various system components described herein. For instance, one or more communicative links or interfaces (e.g., one or more data buses) may be provided between the communications interface 208 and the sensor(s) 112, 113, 114, 116 to allow the computing system 202 to receive: data directly indicative of the actual flow direction of trash exhausted from the harvester 10 and, optionally, a position of a trailer relative to the harvester 10 from the sensor(s) 112A, 112B; data indirectly indicative of the flow direction of trash from the wind sensor(s) 113; data indicative of a position of the shrouds 55, 79; and/or data indicative of a position of the harvester 10 and a position of a trailer from the vehicle position sensor(s) 116. Moreover, one or more data buses may be provided between the communications interface 208 and the slew drive device(s) 118, 120 to allow the computing system 202 to control an operation of the slew drive device(s) 118, 120 to adjust a position of the outlet 55B, 79B of the shrouds 55, 79. Additionally, one or more data buses may be provided between the communications interface 208 and the user interface(s) 210 to allow the computing system 202 to control an operation of the user interface(s) 210.

In accordance with aspects of the present subject matter, the computing system 202 may be configured to determine a flow direction of trash exiting the shroud(s) 55, 79 of the extractor assembly(ies) 54, 78 of the agricultural harvester 10. More particularly, the shroud 55 of the primary extractor assembly 54 is oriented such that the trash exiting the harvester 10 via the outlet 55B of the shroud 55 is preferably evenly distributed across the field rearwardly of the harvester 10. As is generally understood, the more even a residue or trash layer across the field is after harvesting, the better the moisture control and the organic matter control in the field for subsequent planting. However, due to wind, the trash exhausted by the primary extractor assembly 54 may not be as evenly distributed. Similarly, the shroud 79 of the secondary extractor assembly 78 is oriented such that the trash exiting the harvester 10 via the outlet 79B of the shroud 79 generally passes over a trailer, while the elevator assembly 52 is oriented such that crop expelled through the outlet 64 of the elevator assembly 52 is received by the trailer. However, due to wind, the trash exhausted by the secondary extractor assembly 78 may be redirected into the trailer with the crop, which negates the separation process of the secondary extractor assembly 78. As such, the computing system 202 is configured to determine the flow direction of the trash exiting the extractor assembly(ies) 54, 78 to maintain the ideal distribution of the trash.

In several embodiments, the computing system 202 may determine the flow direction of the trash exiting the extractor assembly(ies) 54, 78 based at least in part on data from the sensor(s) 112, 113, 114. For instance, in one embodiment, as indicated above, data from the first sensor(s) 112A may be directly indicative of the actual flow direction of the trash exiting the primary extractor assembly 54, and data from the second sensor(s) 112B may be directly indicative of the actual flow direction of the trash exiting the secondary extractor assembly 78. As such, the computing system 202 may be configured to determine the actual flow direction of the trash exiting the extractor assembly(ies) 54, 78 based directly on analysis of the data. The computing system 202 may be configured to perform any suitable image processing techniques to determine the flow direction of the trash. Suitable processing or analyzing techniques may include performing spatial analysis on received images or image data. For instance, geometric or spatial processing algorithms, shape detection and/or edge-finding or perimeter-finding algorithms, and/or the like may differentiate the shape, color, edges, and/or the like of the trash from the crop or environmental features, and then track the general flow direction and/or speed of the trash. Alternatively, or additionally, in some embodiments, data from the wind sensor(s) 113 and data from the shroud position sensor(s) 114 may be indirectly indicative of the flow direction of the trash. For instance, the computing system 202 may determine the direction and/or speed of the wind flowing past the harvester 10 based at least in part on the data from the wind sensor(s) 113, which may be used to infer the flow direction and/or speed of the trash, and thus, confirm the readings from the flow direction sensors 112A, 112B.

The computing system 202 may further determine the position of the outlet(s) 55B, 79B (e.g., slew angle) of the shroud(s) 55, 79 about the axis(es) 102, 106 based at least in part on the data from the shroud position sensor(s) 114. In one embodiment, the shroud position sensor(s) is configured as any suitable sensor configured to determine the rotational position of the shroud(s) 55, 79 about the axis(es) 102, 106, such as a rotary encoder, an optical encoder, and/or the like. The computing system 202 may then be configured to determine the flow direction of the trash based at least in part on the wind direction and/or wind speed and the position (e.g., slew angle) of the outlet(s) 55B, 79B of the shroud(s) 55, 79.

In some embodiments, the computing system 202 may determine the flow direction of the trash exiting the secondary extractor 78 relative to the trailer (e.g., trailer 152 in FIGS. 3A and 3B). For instance, the data from the flow direction sensor(s) 112A, 112B may include at least a portion of the trailer 152. As such, the computing system 202 may be configured to determine a position of the trailer in addition to the flow direction based at least in part on the data. In such embodiments, the computing system 202 may directly determine the flow direction of the trash relative to the trailer. Alternatively, or additionally, data from the vehicle position sensor(s) 116 may be indicative of the position of the harvester 10 and a position of the trailer. For example, the vehicle position sensor(s) 116 may include a GPS system, a Galileo positioning system, the Global Navigation satellite system (GLONASS), the BeiDou Satellite Navigation and Positioning system, and/or the like. Thus, the computing system 202 may be configured to determine a position of the trailer relative to the harvester 10 based on the position data from the vehicle position sensor(s) 116. After the position of the trailer relative to the harvester 10 is identified based on the position data, the computing system 202 may determine the flow direction of the trash exiting the secondary extractor 78 relative to the trailer.

Once the flow direction of the trash is determined, the computing system 202 may be configured to compare the flow direction to an ideal flow direction. For instance, as indicated above, an ideal flow direction for the trash exhausted by the primary extractor assembly 54 results in the trash being evenly spread behind the harvester 10 (opposite the direction of travel 11). Similarly, as indicated above, an ideal flow direction for the trash exhausted by the secondary extractor assembly 78 is any direction that results in the trash being directed away from the trailer. If the flow direction of the trash determined based on the data from the sensor(s) 112, 113, 114, 116 does not match the ideal flow direction, the computing system may determine an updated orientation (e.g., slew angle) for the shroud(s) 55, 79 in response to the flow direction. The computing system 202 may be configured to determine the updated orientation of the shroud(s) 55, 79 using any suitable relationship or algorithm stored within its memory 206. For instance, the computing system 202 may be configured to determine the updated orientation of the shroud(s) 55, 79 based at least in part on one or more of the current flow direction, the current flow speed, the current shroud position (e.g., the current slew angle), the position of the trailer, the current wind direction, and/or the like. After determining the updated orientation of the shroud(s) 55, 79, the computing system 202 may control the operation of the slew drive device(s) 118, 120 to rotate the shroud(s) 55, 79 about the axis(es) 102, 106 from the current orientation to the updated orientation.

Additionally, in some embodiments, the computing system 202 may be configured to determine whether it is necessary to change a position of the trailer or the harvester 10 in addition to altering the orientation of the shroud(s) 55, 79. For instance, if the computing system 202 detects that the flow direction of the trash after adjusting the position of the shroud(s) 55, 79 to the updated orientation is not enough to completely account for the wind, the computing system 202 may be configured to determine a preferred position for the trailer relative to the harvester 10. The computing system 202 may then be configured to communicate the preferred position for the trailer relative to the harvester 10 to an operator of the trailer and/or harvester 10 via the user interface 210. In one embodiment, the computing system 202 may be configured to automatically control the operation of a drive system of the harvester 10 to change the position of the harvester 10 relative to the trailer in accordance with the preferred position. Alternatively, or additionally, in some embodiments, the computing system 202 may be configured to automatically control the operation of a drive system of the trailer (or a vehicle towing the trailer) to change the position of the trailer relative to the harvester 10 in accordance with the preferred position.

Referring now to FIGS. 3A and 3B, top-down views of one embodiment of an agricultural system 150 are illustrated, particularly illustrating adjustment of a slew angle of shrouds of an agricultural harvester, such as the shrouds 55, 79 of the agricultural harvester 10. As generally indicated above, the agricultural harvester 10 may be configured to harvest and process crop within a field, where the processed crop (e.g., billets 51) may then be delivered to an external storage device, and where the trash 53 separated from the crop 51 by the extractor assemblies 54, 78 exits the harvester 10. For instance, the agricultural system 150 includes the harvester 10 and a crop storage container or trailer 152 (hereinafter referred to as “trailer 152”). The trailer 152 is configured to receive crop material expelled from the outlet end 64 of the elevator assembly 52. In some embodiments the trailer 152 is towed alongside the harvester 10, proximate the outlet end 64 of the elevator assembly 52, by a trailer vehicle 154 (e.g., a tractor). However, in other embodiments, the trailer 152 may be towed by the harvester 10.

Depending on wind during the harvesting operation, the flow of trash exiting the shrouds 55, 79 of the extractor assemblies 54, 78 may be directed in an undesirable way. For instance, as shown in FIG. 3A, the slew angle of the shroud 55 of the primary extractor assembly 54 orients the outlet 55B of the shroud 55 to open directly rearwardly of the harvester 10 such that the trash 53 may be directed across a swath S1 worked by the harvester 10. However, the flow of the trash 53 exiting the shroud 55 of the primary extractor assembly 54 via the outlet 55B is instead re-directed by wind W1 toward one side of the swath S1. Similarly, the slew angle of the shroud 79 of the secondary extractor 78 orients the outlet 79B of the shroud 79 to open towards an opposite side of the trailer 152, such that the trash 53 may be directed to pass over the top of the trailer 152, while the heavier crop 51 is received by the trailer 152. However, the flow of the trash 53 exiting the shroud 79 of the secondary extractor assembly 78 via the outlet 79B is instead re-directed by the wind W1 such that it blows at least partially into the trailer 152 and recombines with the crop 51.

Accordingly, as shown in FIG. 3B, the shrouds 55, 79 of the extractor assemblies 54, 78 may be slewed to account for the wind W1. For instance, the shroud 55 of the primary extractor assembly 54 may be slewed about the axis 102 such that the outlet 55B of the shroud 55 opens toward the side of the swath S1 opposite the side of the swath S1 that the wind W1 pushes toward in FIG. 3A. As such, the flow of trash 53 exiting the shroud 55 is more evenly distributed by the wind W1 across the swath S1 in FIG. 3B. Similarly, the shroud 79 of the secondary extractor assembly 78 may be slewed about the axis 106 from its position in FIG. 3A to the position shown in FIG. 3B such that the outlet 79B of the shroud 79 opens to exhaust the flow of trash 53 in the same general direction as the wind W1. As such, the flow of trash 53 exiting the shroud 79 is largely prevented from falling into the trailer 152.

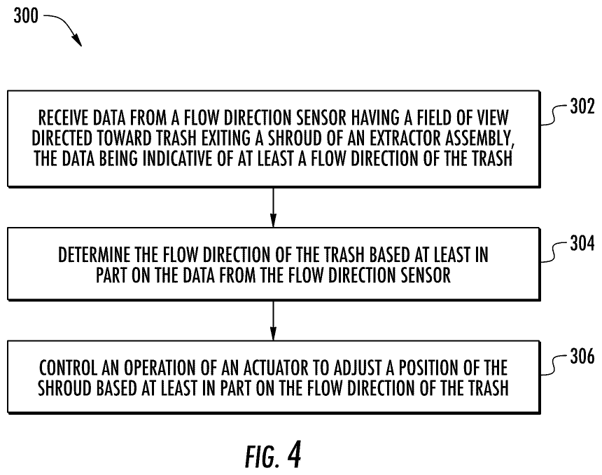

Referring now to FIG. 4, a flow diagram of one embodiment of a method 300 for removing trash from a flow of harvested crop within an agricultural harvester is illustrated in accordance with aspects of the present subject matter. In general, the method 300 will be described herein with reference to the agricultural harvester 10 described with reference to FIG. 1, the various components of the system 200 described with reference to FIG. 2, and the agricultural system 150 described with reference to FIGS. 3A and 3B. However, it should be appreciated that the disclosed method 300 may be implemented with harvesters having any other suitable configurations, within systems having any other suitable system configuration, and/or with agricultural systems having any other suitable configuration. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 4, at (302), the method 300 may include receiving data from a flow direction sensor having a field of view directed toward trash exiting a shroud of an extractor assembly, the data being indicative of at least a flow direction of the trash. For example, as indicated above, the computing system 202 may receive data from the flow direction sensor(s) 112A, 112B having a field of view(s) directed toward trash 53 exiting the shroud(s) 55, 79 of the extractor assembly(ies) 54, 78 via the outlet(s) 55B, 79B of the shroud(s) 55, 79, the data being indicative of the flow direction of the trash 53.

Further, at (304), the method 300 may include determining the flow direction of the trash based at least in part on the data from the flow direction sensor. For instance, as discussed above, the computing system 202 may determine the flow direction of the trash 53 based at least in part on the data from the flow direction sensor(s) 112A, 112B.

Additionally, at (306), the method 300 may include controlling an operation of an actuator to adjust a position of the shroud based at least in part on the flow direction of the trash. For instance, as described above, the computing system 202 may control an operation of the slew drive device(s) 118, 120 to adjust a position (e.g., slew direction) of the shroud(s) 55, 79 to change an orientation of the outlet(s) 55B, 79B based at least in part on the flow direction of the trash 53.

It is to be understood that the steps of the method 300 are performed by the computing system 200 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 200 described herein, such as the method 300, is implemented in software code or instructions which are tangibly stored on a tangible computer readable medium. The computing system 200 loads the software code or instructions via a direct interface with the computer readable medium or via a wired and/or wireless network. Upon loading and executing such software code or instructions by the computing system 200, the computing system 200 may perform any of the functionality of the computing system 200 described herein, including any steps of the method 300 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An agricultural system for removing trash from a flow of harvested crop within an agricultural harvester, the agricultural system comprising:
an extractor assembly comprising a shroud and an actuator, the shroud having an inlet through which trash from the flow of harvested crop enters the shroud and an outlet through which the trash exits the shroud, the actuator being configured to adjust a position of the shroud;
a flow direction sensor having a field of view directed toward the trash exiting the shroud, the flow direction sensor being configured to generate data indicative of at least a flow direction of the trash exiting the shroud; and
a computing system communicatively coupled to the actuator and the flow direction sensor, the computing system being configured to:
determine the flow direction of the trash exiting the shroud based at least in part on data received from the flow direction sensor; and
control an operation of the actuator to adjust the position of the shroud based at least in part on the flow direction of the trash.

2. The agricultural system of claim 1, further comprising an elevator assembly having an elevator disposed within an elevator housing, the elevator being configured to transport the flow of harvested crop from an inlet end of the elevator housing to an outlet end of the elevator housing,
wherein the extractor assembly is positioned closer to the outlet end of the elevator housing than the inlet end of the elevator housing, the shroud being movable relative to the elevator housing.

3. The agricultural system of claim 2, further comprising a trailer towed relative to the agricultural harvester, the trailer being configured to receive at least a portion of the flow of harvested crop expelled from the outlet end of the elevator assembly.

4. The agricultural system of claim 3, wherein the computing system is configured to determine the flow direction of the trash relative to the trailer based at least in part on the data from the flow direction sensor, and
wherein the computing system is configured to control the operation of the actuator to adjust the position of the shroud based at least in part on the flow direction of the trash relative to the trailer.

5. The agricultural system of claim 3, wherein the computing system is further configured to determine a position of the trailer based at least in part on data received from a trailer position sensor,
wherein the computing system is configured to determine the flow direction of the trash relative to the trailer based at least in part on the data from the flow direction sensor and the position of the trailer, and
wherein the computing system is configured to control the operation of the actuator to adjust the position of the shroud based at least in part on the flow direction of the trash relative to the trailer.

6. The agricultural system of claim 5, wherein the computing system is further configured to determine a preferred position of the trailer relative to the shroud based at least in part on the data from the flow direction sensor and the position of the trailer.

7. The agricultural system of claim 1, further comprising an elevator assembly having an elevator disposed within an elevator housing, the elevator being configured to transport at least a portion of the flow of harvested crop from an inlet end of the elevator housing to an outlet end of the elevator housing,
wherein the extractor assembly is positioned closer to the inlet end of the elevator housing than the outlet end of the elevator assembly.

8. The agricultural system of claim 1, further comprising a vane configured to generate data indicative of a wind direction relative to the agricultural harvester,
wherein the computing system is configured to determine the flow direction of the trash exiting the shroud based at least in part on data received from the flow direction sensor and the data from the vane.

9. The agricultural system of claim 1, wherein the flow direction sensor comprises at least one of an optical sensor or a radar device configured to generate the data indicative of the flow direction of the trash.

10. The agricultural system of claim 1, wherein the data from the flow direction sensor is indicative of both the flow direction of the trash and a speed of the trash exiting the shroud.

11. An agricultural method for removing trash from a flow of harvested crop within an agricultural harvester, the agricultural harvester comprising an extractor assembly comprising a shroud having an inlet through which trash from the flow of harvested crop enters the shroud and an outlet through which the trash exits the shroud, the agricultural method comprising:
receiving, with a computing system, data from a flow direction sensor having a field of view directed toward the trash exiting the shroud, the data being indicative of at least a flow direction of the trash exiting the shroud;
determining, with the computing system, the flow direction of the trash based at least in part on the data from the flow direction sensor; and
controlling, with the computing system, an operation of an actuator to adjust a position of the shroud based at least in part on the flow direction of the trash.

12. The agricultural method of claim 11, the agricultural system further comprising an elevator assembly having an elevator disposed within an elevator housing, the elevator being configured to transport the flow of harvested crop from an inlet end of the elevator housing to an outlet end of the elevator housing,
wherein the extractor assembly is positioned closer to the outlet end of the elevator housing than the inlet end of the elevator housing, the shroud being movable relative to the elevator housing.

13. The agricultural method of claim 12, the agricultural system further comprising a trailer towed relative to the agricultural harvester, the trailer being configured to receive at least a portion of the flow of harvested crop expelled from the outlet end of the elevator assembly.

14. The agricultural method of claim 13, wherein determining the flow direction of the trash comprises determining the flow direction of the trash relative to the trailer based at least in part on the data from the flow direction sensor, and
wherein controlling the operation of the actuator comprises controlling the operation of the actuator to adjust the position of the shroud based at least in part on the flow direction of the trash relative to the trailer.

15. The agricultural method of claim 13, further comprising determining, with the computing system, a position of the trailer based at least in part on data received from a trailer position sensor,
wherein determining the flow direction of the trash comprises determining the flow direction of the trash relative to the trailer based at least in part on the data from the flow direction sensor and the position of the trailer, and
wherein controlling the operation of the actuator comprises controlling the operation of the actuator to adjust the position of the shroud based at least in part on the flow direction of the trash relative to the trailer.

16. The agricultural method of claim 15, further comprising determining, with the computing system, a preferred position of the trailer relative to the shroud based at least in part on the data from the flow direction sensor and the position of the trailer.

17. The agricultural method of claim 11, the agricultural system further comprising an elevator assembly having an elevator disposed within an elevator housing, the elevator being configured to transport at least a portion of the flow of harvested crop from an inlet end of the elevator housing to an outlet end of the elevator housing,
wherein the extractor assembly is positioned closer to the inlet end of the elevator housing than the outlet end of the elevator assembly.

18. The agricultural method of claim 11, further comprising receiving data indicative of a wind direction relative to the agricultural harvester,
wherein determining the flow direction of the trash comprises determining the flow direction of the trash based at least in part on the data from the flow direction sensor and the data indicative of the wind direction relative to the agricultural harvester.

19. The agricultural method of claim 11, wherein the flow direction sensor comprises at least one of an optical sensor or a radar device configured to generate the data indicative of the flow direction of the trash.

20. The agricultural method of claim 11, wherein the data from the flow direction sensor is indicative of both the flow direction of the trash and a speed of the trash exiting the shroud.
